(19) United States
(12) Patent Application Publication
(10) Pub. No.: US 2009/0157951 A1
(43) Pub. Date: Jun. 18, 2009

(54) INFORMATION RECORDING DEVICE AND INFORMATION RECORDING METHOD

(75) Inventor: Takuya KONTANI, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/199,544

(22) Filed: Aug. 27, 2008

(30) Foreign Application Priority Data
Dec. 17, 2007 (JP) 2007-324823

(51) Int. Cl. G06F 12/00

(52) U.S. Cl. 711/103; 711/E12.001

(57) ABSTRACT

An information recording device includes a table showing a physical address in first and second areas and a number of rewriting at the physical address in a correspondence manner, the first area being a writing destination in a recording medium configured to be consumed by rewriting, the second area being not a writing destination in the recording medium, an instructor configured to instruct to change the first and second tables based on the first table and the physical address of the writing destination, a changer configured to change the table based on the instruction, and a writer configured to write data to the recording medium based on the physical address in the first area.

### CROSS REFERENCE TO RELATED APPLICATIONS

This application is based upon and claims the benefit of priority from the prior Japanese Patent Application No. 2007-324823, filed on Dec. 17, 2007; the entire contents of which are incorporated herein by reference.

### BACKGROUND OF THE INVENTION

1. Field of the Invention

The present invention relates to an information recording device and an information recording method, for writing data to a recording medium which is consumed by rewriting data.

2. Description of the Related Art

There are recording mediums, which are consumed by rewriting data (for example, a flash memory). In this type of recording mediums, the numbers of rewritings in the entire recording medium are averaged to elongate lifetime of the recording medium. A technology for improving the speed of a process for averaging the numbers of rewritings has been disclosed. A deletion unit, which is a data transfer destination, is determined based on control information that links deletion units of memories (see JP-A 08-124393 (KOKAI)).

### BRIEF SUMMARY OF THE INVENTION

Since the deletion units are related in the control information, a complicated process is required to determine a deletion unit, and the determination is not always efficiently executed. In view of this problem, the present invention has an object to provide an information recording device and an information recording method, which are capable of efficiently controlling the number of rewritings.

An information recording device according to an aspect of the present invention includes a table showing a physical address in first and second areas and a number of rewriting at the physical address in a correspondence manner, the first area being a writing destination in a recording medium configured to be consumed by rewriting, the second area being not a writing destination in the recording medium, an instructor configured to instruct to change the first and second tables based on the first table and the physical address of the writing destination, a changer configured to change the table based on the instruction, and a writer configured to write data to the recording medium based on the physical address in the first area.

An information recording method according to an aspect of the present invention, in an information recording device having a table showing a physical address in first and second areas and a number of rewriting at the physical address in a correspondence manner, the first area being a writing destination in a recording medium configured to be consumed by rewriting, the second area being not a writing destination in the recording medium, the information recording method includes instructing a change of the table based on the table and the physical address of the writing destination, changing the table based on the instruction, and writing data to the recording medium based on the physical address in the first area.

### BRIEF DESCRIPTION OF THE DRAWINGS

FIG. 1 is a block diagram showing an information recording and reproducing system according to a first embodiment of the present invention.

FIG. 2 is a schematic view showing a storage area of a flash memory 202.

FIG. 3 is a schematic view showing an example of an area management table.

FIG. 4 is a schematic view showing an example of an area management table.

FIG. 5 is a schematic view showing an example of an address conversion table;

FIG. 6 is a flowchart showing an example of an operation procedure of an information recording device.

FIG. 7 is a schematic view showing a swap between an access area and a non-access area.

FIG. 8 is a schematic view showing an addition to the access area.

FIG. 9 is a schematic view showing a deletion from the access area.

FIG. 10 is a block diagram showing an information recording and reproducing system according to a second embodiment of the present invention.

### DETAILED DESCRIPTION OF THE INVENTION

Embodiments of the present invention will be described with reference to the drawings.

### First Embodiment

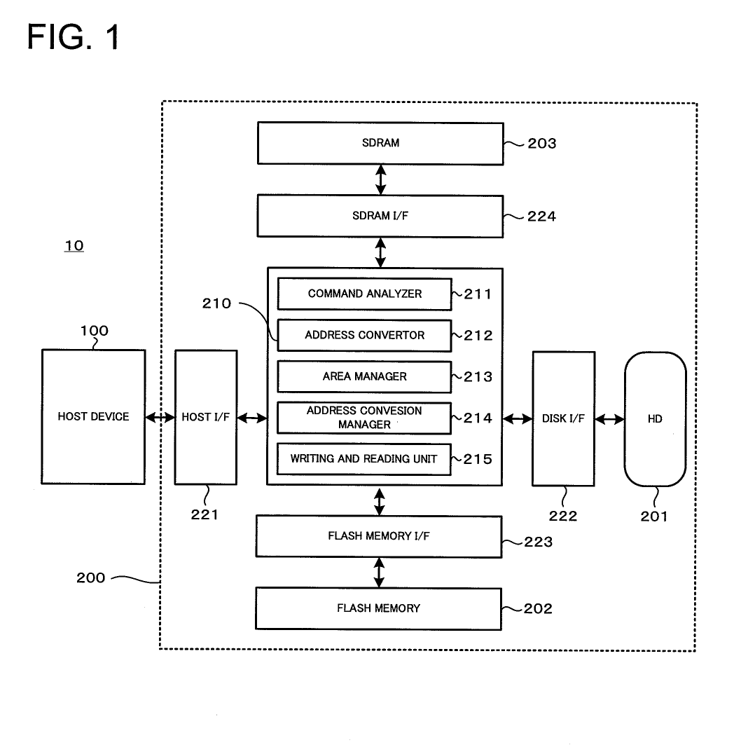

FIG. 1 is a block diagram showing an information recording and reproducing system 10 according to a first embodiment of the present invention. The information recording and reproducing system 10 has a host device 100 and an information recording device 200.

The information recording device 200 has a hard disk (HD) 201, a flash memory 202, an SDRAM 203, a controller 210, a host interface (I/F) 221, a disk interface (I/F) 222, a flash memory interface (I/F) 223 and an SDRAM interface (I/F).

The host device 100 is a device for writing information to or reading information from the information recording device 200 and serves like a control unit in a personal computer. The host device 100 sends a command to the controller 210 via the host interface 221. The host device 100 also receives data from the controller 210 via the host interface 221.

The controller 210 sends data to and receive data from the HD 201, flash memory 202 and SDRAM 203 via the disk interface 222, flash memory interface 223 and SDRAM interface 224, respectively.

The HD 201 has a magnetic disk, a spindle motor, a magnetic head and an arm. The magnetic disk is a recording medium for recording information. The spindle motor rotates the magnetic disk. The magnetic head writes data to and read data from the magnetic disk. The arm holds the magnetic head to move the magnetic head on the magnetic disk.

The flash memory 202 is a recording medium for recording data and can be used as a cache when recording data to the HD 201. In other words, data can be written only to the flash memory 202 or written to the HD 201 and flash memory 202 in parallel.

The flash memory 202 is a nonvolatile memory and capable of electrically deleting and writing data again, that is, a data writing. When the number of the rewriting increases, elements of the flash memory 202 are deteriorated. This can cause errors (for example, a read disturb or a data retention) and the content of the rewriting can be destroyed. In other words, the flash memory 202 is a recording medium, which is consumed by rewriting. As a guarantee of the performance of the flash memory 202, the number of rewriting is defined as about one hundred thousand times, for example.

A storage area of the flash memory 202 is managed based on a unit area U of predetermined bytes. In other words, data is collectively deleted in a unit area U basis. The size of the unit area U is determined accordingly when the flash memory 202 is formatted.

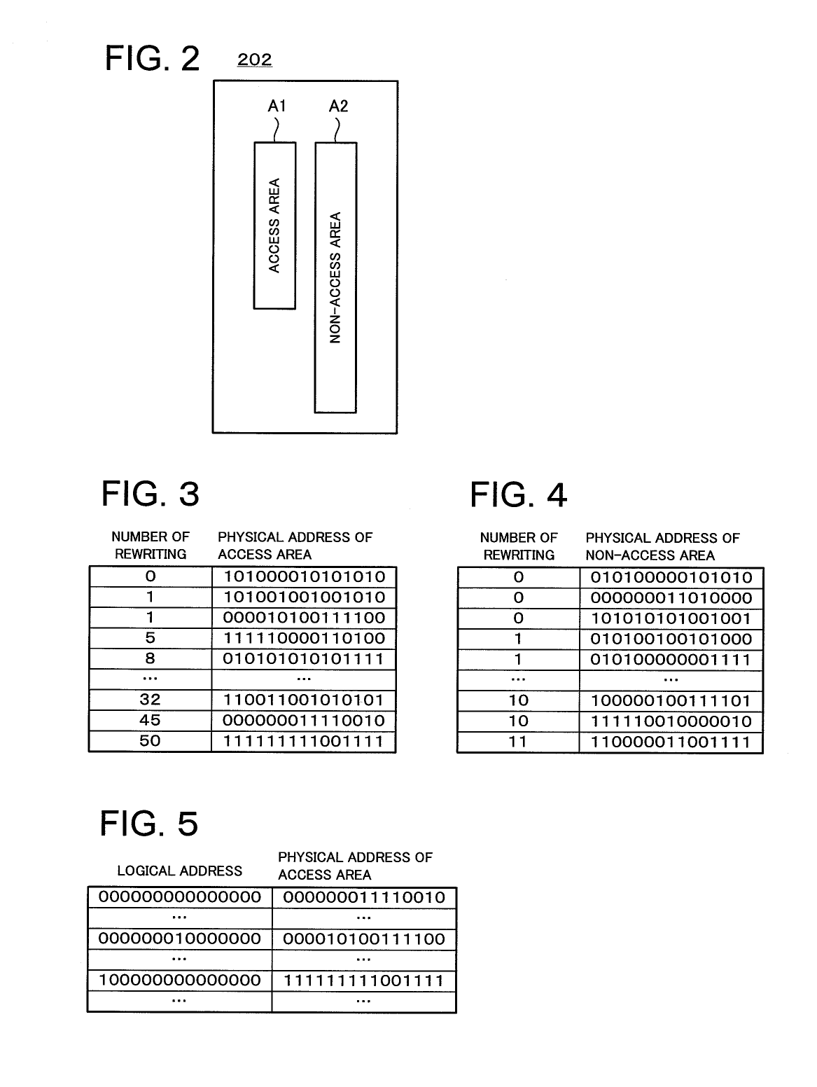

FIG. 2 is a schematic view showing a storage area of the flash memory 202. The storage area of the flash memory 202 is divided into access areas A1 and non-access areas A2. The access area A1 is a storage area accessible by an external device (host device 100). The non-access area A2 is a storage area (storage area for pooling), which is not accessed from the external device (host device 100). In other words, the access area A1 and non-access area A2 correspond to a first area to be written of the recording medium and a second area not to be written on the recording medium, respectively.

In FIG. 2, in purpose of simplification, the access area A1 and non-access area A2 are respectively shown as an integrated area. However, the access area A1 and non-access area A2 can be separately disposed.

The access area A1 and non-access area A2 are managed based on later-described area management tables T1, T2 (an access area management table T1 and a non-access area management table T2). The access area A1 and non-access area A2 correspond to the area management tables T1, T2, respectively.

The SDRAM 203 stores the area management tables T1, T2 and an address conversion table T3. The SDRAM 203 is also used as a buffer when recording to the HD 201.

FIGS. 3 and 4 are schematic views showing examples of the area management tables T1, T2. The area management tables T1, T2 respectively show physical addresses of the access areas A1 and non-access areas A2 and the numbers of rewriting in a correspondence manner. The physical addresses indicate addresses representing the unit areas U of the respective access area A1 and non-access area A (for example, a first address of one unit area U). The numbers of rewritings indicate the number of rewriting in one unit area U. In the area management tables T1, T2, the items of sets of the physical address and the number of rewriting are arranged in order of the number of the rewriting. In other words, the information of the physical addresses is arranged in order of the numbers of writing so that the speed of the processes such as writing data is improved.

The area management tables T1, T2 are stored in a medium (SDRAM 203), which is different from the flash memory 202 to be managed. Since the area management tables T1, T2 are stored in the medium, which is not consumed by rewriting, safety of the management can be maintained.

The area management tables T1, T2 for recording the number of access are frequently accessed. Thus, when the area management tables T1, T2 are stored in the flash memory 202, the number of the rewriting increases and this can cause errors. To prevent this problem, it is required to regularly change the place where the area management tables T1, T2 are stored. According to the present embodiment, since the area management tables T1, T2 are placed in a different medium (SDRAM 203), extra operations for protecting the area management tables T1, T2 are not required and the operation can be made simple.

FIG. 5 is a schematic view showing an example of the address conversion table T3. The address conversion table T3 shows logical addresses and the physical addresses of the access areas A1 in a correspondence manner and used to convert the logical addresses into the physical address of the access areas A1. In other words, the physical addresses in the address conversion table T3 are only those of the access areas A1 and the physical address of the non-access areas A2 are not included. When a logical address is specified between the host device 100 and controller 210, a physical address corresponding to the logical address is only the physical address of the access area A1. With this structure, the access from the host device 100 to the non-access area A2 is restricted.

To the data recorded in the HD 201 and flash memory 202, an error correcting code is added. An ECC process is performed on data recorded in the flash memory and the hard disk to provide an error correction when the data is reproduced.

The controller 210 has a command analyzer 211, an address convertor 212, an area manager 213, an address conversion manager 214 and a writing and reading unit 215.

The command analyzer 211 analyzes a command transmitted from the host device 100. The command is for a data writing instruction, a data reading instruction, a data transfer, memorizing, information reading instruction, for example. The command analyzer 211 serves as a writing detector for detecting a writing command from the host device 100.

The address convertor 212 converts the logical address to the physical address using the address conversion table T3.

The area manager 213 manages the area management tables T1, T2. Specifically, the area manager 213 functions as following (1) to (5):
(1) a determiner determining to change first and second tables based on the first table and a physical address of a writing target;
(2) changer changing the first and second tables;
(3) transferor transferring a physical address in the second table to the first table;
(4) second transferor transferring a physical address in the first table to the second table; and
(5) second updater updating the first and second tables corresponding to an order of the number of rewriting.

The address conversion manager 214 manages the address conversion table T3. The address conversion manager 214 serves as an updater updating a third table showing the logical addresses and physical addresses in the first table in a correspondence manner.

The writing and reading unit 215 writes data to and read data from the HD 201, the flash memory 202 and the SDRAM 203. The writing and reading unit 215 serves as a writer writing data to the recording medium and as a second writer writing data to a magnetic recording medium.

### (Operation of Information Recording Device 200)

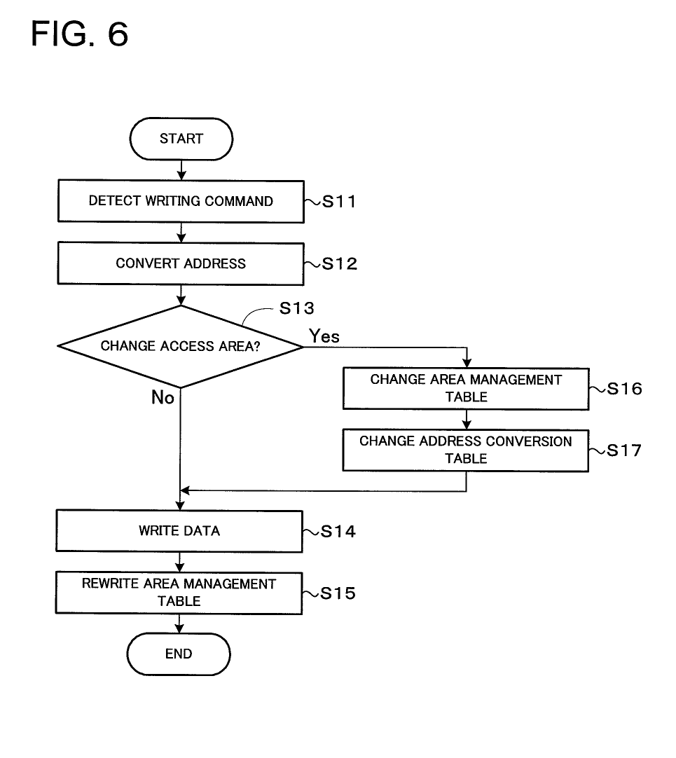

A operation procedure of the information recording device 200 will be described. FIG. 6 is a flowchart showing an example of an operation procedure of the information recording device 200.

### (1) Detecting a Writing Command (Step S11)

The command analyzer 211 detects a writing command sent from the host device 100. In other words, the host device 100 sends a writing command to instruct the controller 210 to write data, and the command analyzer 211 detects the command.

### (2) Converting Addresses (Step S12)

The address convertor 212 converts logical addresses into physical address in the access area A1 using the address conversion table T3.

### (3) Determining Whether to Change the Access Area A1 (Step S13)

The area manager 213 determines whether or not to change the access area A1. The details will be described later.

### (4) Writing Data and Updating the Area Management Table T1 (Steps S14, S15)

When the area manager 213 determines that a change of the access area A1 is not necessary, data is written in a unit area U corresponding to the converted physical address (step S14).

Then, the area manager 213 updates the area management table T1 (step S15). The number of rewriting corresponding to the physical address of the unit area U where the data is written (addition of the number of rewritings) and the items composed of a physical address and the number of rewriting are rearranged according to the order of the numbers of rewriting. In other words, when a rewrite to the unit area U occurs, the physical address of the unit area U is transferred to the lower part (larger numbers of rewriting) of the area management table T1. In this case, only the area management table T1 is rewritten and a swap between the unit areas U does not occur in the storage area of the flash memory 202.

### (5) Changing the Area Management Table T1 and Updating the Address Conversion Table T3 (Steps S16, S17)

When the area manager 213 determines that the change of the area management table T1 is necessary, the area manager 213 changes the area management table T1 (step S16). Then, according to need, the area management tables T1, T2 are sorted and the items are rearranged according to the order of the numbers of the writing.

According to the change of the area management table T1, the address conversion manager 214 updates the address conversion table T3 (step S17). This process is executed in order to make the address conversion table T3 correspond to the changes in the area management table T1.

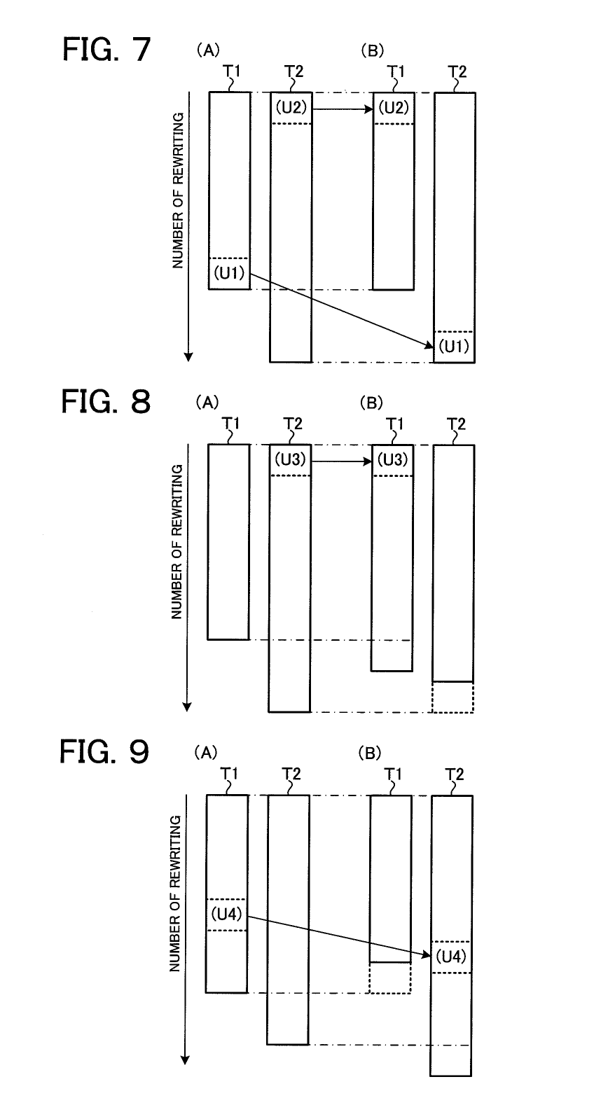

The details of the change in the area management table T1 will be described. As an example of the change in the area management table T1, the following A to C can be given. FIGS. 7 to 8 are schematic views corresponding to A to C. In FIGS. 7 and 8, (A) and (B) respectively represent the area management tables T1, T2 before and after the change.

### A. Swapping Unit Areas U Between the Access Area A1 and the Non-Access Area A2

As an example of the change in the area management table T1, a swap of one or more unit areas U between the access area A1 and non-access area A2 can be considered.

(1) In this case, in step S13, the necessity of this swap is determined based on the converted physical address and the area management table T1. For example, when the unit area U1 corresponding to the converted physical address has the largest number of rewriting in the access area A1, it is determined that a swap between the access area A1 and the non-access area A2 is necessary.

(2) In step S16, for example, the lowest unit area U1 (having the largest number of rewriting) in the area management table T1 is deleted and transferred to the area management table T2. The highest unit area U2 (having the smallest number of rewriting) in the area management table T2 is transferred to the area management table T1. Here, the unit areas U are exchanged between the area management tables T1, T2 (see FIG. 7). The unit area U2 is assigned to the access area A1 and becomes a new area to be written. On the other hand, the unit area U1 is assigned to the non-access area A2 and becomes an area not to be written (release of memory). As the area management tables T1, T2 are rewritten, the unit areas U1, U2 are exchanged between the access area A1 and the non-access area A2.

(3) In step S17, as a substitute for the physical address of the unit area U1, the physical address of the unit area U2 is assigned in the address conversion table T3.

When data is repeatedly rewritten in the flash memory 202, the item (a set of a physical address and the number of rewriting) in the area management table T1 is transferred to a lower part. When a rewrite to the unit area U1 corresponding to the lowest item in the area management table T1 occurs, the unit area U1 is exchanged with the unit area U2 having the smallest number of rewritings in the non-access area A2. In other words, the unit area U1 is moved to the area management table T2. The unit area U2 (corresponding to the highest item in the area management table T2) is transferred to the access area A1. Further, the unit area U corresponding to the lowest item in the area management table T2 is not used until it becomes the highest item in the area management table T2 by additions of subsequent unit areas U.

As a result of this process, the unit areas U are used by turns between the access area A1 and the non-access area A2 so that the number of the rewriting can be averaged.

Further, a swap of the unit area U between the access area A1 and the non-access area A2 is executed only when a rewrite of a unit area U corresponding to the lowest item of the area management table T1 occurs. Thus, the load of swapping is small and such swapping can be executed in background of writing data to and reading data from the flash memory 202 so that the processing speed can be improved.

When the flash memory 202 is divided into plural banks and swapping is executed in a bank basis, such swapping takes time in general. According to the present embodiment, since the unit area U in one swapping is small, the swapping can be executed in background of writing data to and reading data from the flash memory 202.

### B. Adding Unit Areas U to the Access Area A1

As an example of changing the area management table T1, a case of adding one or more unit areas U to the access area A1 can be considered. For example, a unit area U3 in the non-access area A2 is added to the access area A1 (see FIG. 8). This process can be executed with no relation to the procedure shown in FIG. 6.

For example, this addition is executed in response to a request for adding to the access area A1, which is sent from the host device 100. Specifically, in response to the writing command from the host device 100, the controller 210 notifies that the access area A1 is not enough and addition of an access area A1 is available. For this notification, the host device 100 requests an addition of the access area A1. As a result, the highest unit area U3 in the area management table T2 is transferred to the highest position in the area management table T1, for example.

### C. Deleting Unit Areas U From the Access Area A1

As an example of a change in the area management table T1, a deletion of one or more unit areas U from the access area A1 can be considered. For example, a unit area U4 in the access area A1 is removed and transferred to the non-access area A2 (see FIG. 9). This process can be executed with no relation with the procedure shown in FIG. 6.

For example, the host device 100 requests to release a unit area U4 in the access area A1 and the deletion is executed in response to the request. In this case, the destination area to transfer the unit area U4 can be arbitrarily set. For example, the unit area U4 can be inserted to a bank, which is relatively in a same position or a same bank in the non-access area A2. When averaged and efficient position is set, the load of sorting in the area management table T2 can be reduced.

### Second Embodiment

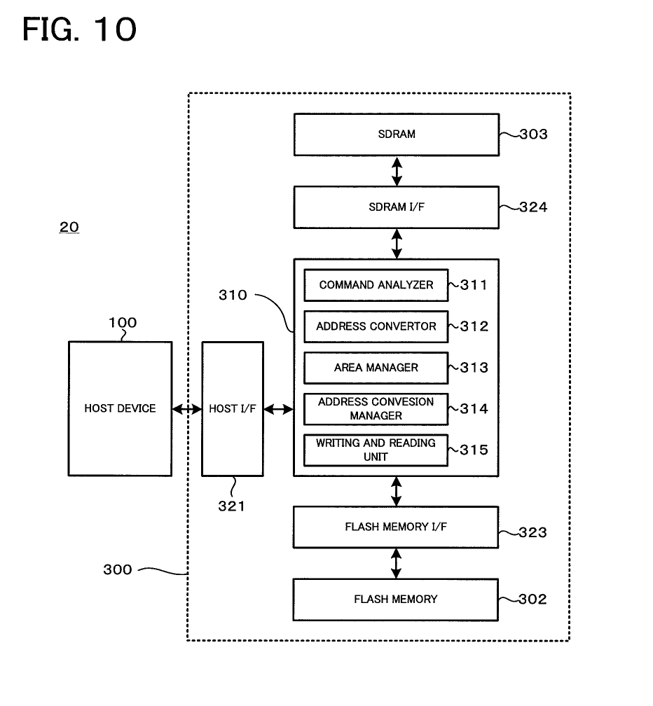

FIG. 10 is a block diagram showing an information recording and reproducing system 20 according to a second embodiment of the present invention. The information recording and reproducing system 20 has a host device 100 and an information recording device 300.

The information recording device 300 has a flash memory 302, an SDRAM 303, a controller 310, a host interface (I/F) 321, a flash memory interface (I/F) 323 and an SDRAM interface (I/F) 324. In other words, different from the information recording device 200, the information recording device 300 does not have an HD 201 and a disk interface (I/F) 222. Thus, the flash memory 302 does not serve as a cache. Further, the SDRAM 303 does not serve as a buffer. Since the information recording and reproducing system 20 is basically the same as the information recording and reproducing system 10 except for the above, detail description will be omitted here.

### Other Embodiment

Embodiments of the present invention are not limited to the above-described embodiments, but the above-described embodiments can be expanded and modified, and the expanded and modified embodiments are also included in the technical range of the present invention.

What is claimed is:

1. An information recording device, comprising:
a table, stored in a recording medium worn by rewriting, comprising a physical address in first and second areas of the recording medium and a number indicative of rewriting operations executed at the physical address, the first area comprises a writing destination in the recording medium, the second area does not comprise a writing destination in the recording medium;
a determination module configured to determine a modification of the table based on contents of the table and the physical address of the writing destination;
a modification module configured to modify the table based on a result from the determination module; and
a writer configured to write data to the recording medium using the physical address in the first area.

2. The information recording device of claim 1,
wherein the table comprises first and second tables, the first table comprising a first physical address in the first area and a number indicative of rewriting operations executed at the first physical address, the second table comprising a second physical address in the second area and a number indicative of rewriting operations executed at the second physical address, and
wherein the determination module is configured to determine modification of the first and second tables based on contents of the first table and the first physical address of the writing destination.

3. The information recording device of claim 2,
wherein the determination module is configured to determine modification of the first and second tables, when the number indicative of rewritings operations executed at the first physical address of the writing destination reaches a predetermined maximum number in the first table.

4. The information recording device of claim 2,
wherein the modification module is configured to swap the first physical address of the maximum number indicative of rewritings operations executed in the first table with the second physical address of a minimum number indicative of rewritings operations executed in the second table.

5. The information recording device of claim 2, further comprising:
a transfer module configured to move the second physical address in the second table to the first table.

6. The information recording device of claim 2, further comprising:
a second transfer module configured to move the first physical address in the first table to the second table.

7. The information recording device of claim 2, further comprising:
the table comprising a third table showing a logical address and the first physical address in the first table;
an address convertor configured to convert the logical address into the first physical address of the writing destination based on contents of the third table; and
an updater configured to update the third table based on a result from the determination module.

8. The information recording device of claim 2, further comprising:
a second updater configured to update the first and second tables sorted by an order of the number of rewriting.

9. The information recording device of claim 2,
wherein the first and second tables are stored in a memory being different from the recording medium.

10. The information recording device of claim 2, further comprising:
a second writer configured to write data to a magnetic recording medium.

11. An information recording method in an information recording device comprising:
storing a table in the recording medium comprising a combination of a physical address in first and second areas of a recording medium worn by rewriting, and a number indicative of rewriting operations executed at the physical address, the first area that comprises a writing destination in the recording medium, the second area does not comprise a writing destination in the recording medium;
the information recording method further comprising:
determining whether to modify the table based on contents of the table and the physical address of the writing destination;
modifying the table based on a result from the determination module; and
writing data to the recording medium using the physical address in the first area.

12. The information recording method of claim 11, further comprising:
providing a first table and a second table, wherein
the first table comprises a first physical address in the first area and a number indicative of rewriting operations executed at the first physical address; and
the second table comprises a second physical address in the second area and a number indicative of rewriting operations executed at the second physical address; and
determining whether to modify the first and second tables based on contents of the first table and the first physical address of the writing destination.

13. The information recording method of claim 12, wherein the modifying step further comprises:
swapping a first physical address of a maximum number indicative of rewriting operations executed in the first table with a second physical address of a minimum number indicative of rewriting operations executed in the second table.

14. The information recording method of claim 12, further comprising:
transferring the second physical address in the second table to the first table.

15. The information recording method of claim 12, further comprising:
transferring the first physical address in the first table to the second table.

16. The information recording method of claim 12, further comprising:
converting a logical address into the first physical address of the writing destination based on contents of a third table showing the logical address and the first physical address in the first table; and
updating the third table based on the determination.

17. The information recording method of claim 12, further comprising:
updating the first and second tables sorted by an order of the number indicative of rewriting operations executed.

18. The information recording method of claim 12,
wherein the first and second tables are stored in a memory being different from the recording medium.

19. The information recording method of claim 12, further comprising:
writing data to a magnetic recording medium.
